(19) United States
(12) Patent Application Publication
(10) Pub. No.: US 2017/0190231 A1
(43) Pub. Date: Jul. 6, 2017

(54) Bushing Assembly

(71) Applicant: Ford Global Technologies, LLC, Dearborn, MI (US)

(72) Inventor: Matt Nutting, Stevenage (GB)

(73) Assignee: Ford Global Technologies, LLC, Dearborn, MI (US)

(21) Appl. No.: 15/235,836

(22) Filed: Aug. 12, 2016

(30) Foreign Application Priority Data
Jun. 25, 2015 (GB) 1511176.8

(51) Int. Cl. B60G 21/055

(52) U.S. Cl. CPC B60G 21/0551; B60G 2204/1222; B60G 2204/41; B60G 2204/4307

(57) ABSTRACT

A bushing assembly having a clamping member producing a clamping force acting on a resilient, compressible bushing interposed between respective bridge portions of a housing portion and a support portion. The clamping member is arranged at substantially ninety degrees with respect to the direction in which a clamping force is applied to the resilient, compressible bushing.

### CROSS-REFERENCE TO RELATED APPLICATIONS

Not Applicable.

### BACKGROUND OF THE INVENTION

1. Field of the Invention

The invention relates to a bushing assembly; and more specifically, to a bushing assembly for use with a vehicle stabilizer bar.

2. Description of Related Art

Attaching a resilient bushing to a structural member of a motor vehicle, such as a stabilizer bar, using a clamp that compresses the bushing as the clamp is secured in position is known.

FIG. 1 shows an example of such a bushing and clamp assembly. The clamp assembly includes a U-shaped clamp member 5 having a base or bridge portion 5b and two outwardly extending flanges 5f securing the clamp member 5 to a bracket or structural member 10. The assembly includes a pair of threaded fasteners 6. One fastener 6 extending through a hole in one flange 5f and threadingly engaging a weld-nut 7 and the other fastener extending through a hole in an opposite flange 5f and threadingly engaging a corresponding weld nut 7. As shown, the fasteners 6 and weld nuts 7 cooperate to hold the clamp member 5 in place on the bracket 10.

A stabilizer bar, shown as bar or shaft 2, is located within a resilient bushing 3. The U-shaped clamp 5 compresses the resilient bushing 3 when the threaded fasteners 6 are tightened. As known, the resilient bushing 3 is larger in an uncompressed state than the space or area defined by the bridge portion 5b of the U-shaped clamp 5 and the bracket 10 when the U-shaped clamp 5 has been secured to the bracket 10.

The direction of the clamping force applied by the U-shaped clamp 5, shown in FIG. 1 by the arrow ‘C’, is in a direction parallel to longitudinal axes x-x of the two fasteners 6. As shown, the two fasteners 6 extend along their respective axes x-x and insertion of the fasteners 6 is along these axes x-x.

Due to the location of the bushing and clamp assembly and intervening components, it is not always possible to access the ends of the threaded fasteners 6 to tighten them or to place the threaded fasteners in position ready for tightening.

### SUMMARY OF THE INVENTION

A bushing assembly including a housing portion having an aperture and a support portion having an aperture. A compressible bushing being interposed between the housing portion and support portion. A clamping member engaging the aperture in the housing portion and the support portion causing displacement between the housing portion and support portion to compress the bushing wherein the clamping member is orientated in the apertures at substantially ninety degrees to a clamping force direction.

In addition, an elongate member may be arranged within the compressible bushing and the compression of the compressible bushing may act so as to clamp the elongate member in the compressible bushing.

Further, the clamping member may include a tapered clamping member. The tapered clamping member may include a frustoconical shank portion.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a diagrammatic side view of a prior art bushing and clamp assembly.

FIG. 2 is a side view of a first embodiment of a bushing and clamp assembly according to an example of the present invention.

FIG. 3 is a partial perspective view on an enlarged scale taken from above showing the misalignment of apertures in clamp and bracket components of the bushing and clamp assembly shown in FIG. 2 prior to final assembly.

FIG. 4 is a side view of a clamping member forming part of the bushing and clamp assembly shown in FIG. 2.

FIG. 5 is a partial, sectional side view of the bushing and clamp assembly shown in FIG. 2 showing a first stage of insertion of the clamping member into the clamp and bracket components.

FIG. 6 is a view similar to FIG. 5 showing the clamping member secured in a final clamping position.

FIG. 7 is a side view showing a second embodiment of a bushing and clamp assembly according to another example of the present invention.

FIG. 8 is an exploded, diagrammatic perspective view of a third embodiment of a bushing and clamp assembly according to a further example of the present invention.

### DETAILED DESCRIPTION OF THE PREFERRED EMBODIMENTS

The following description of the preferred embodiment(s) is merely exemplary in nature and is in no way intended to limit the invention, its application, or uses. Further advantageous details and effects of the invention are explained in the text, which follows with reference to different exemplary embodiments illustrated in the figures, where identical parts are always provided with the same reference symbol throughout the different figures, and said parts are also generally described only once.

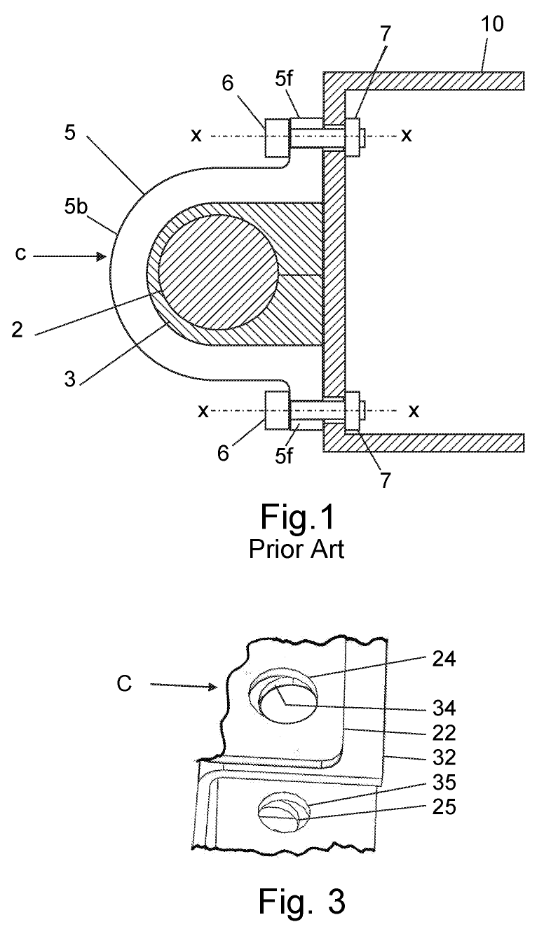

Instead of using fasteners that apply a clamping force in a direction parallel to the longitudinal axes x-x of the fasteners in the manner stated in prior art FIG. 1, the exemplary embodiment of the invention shows a bushing and clamp assembly where the clamping member extends in a direction perpendicular to the direction of the clamping force applied to the bushing.

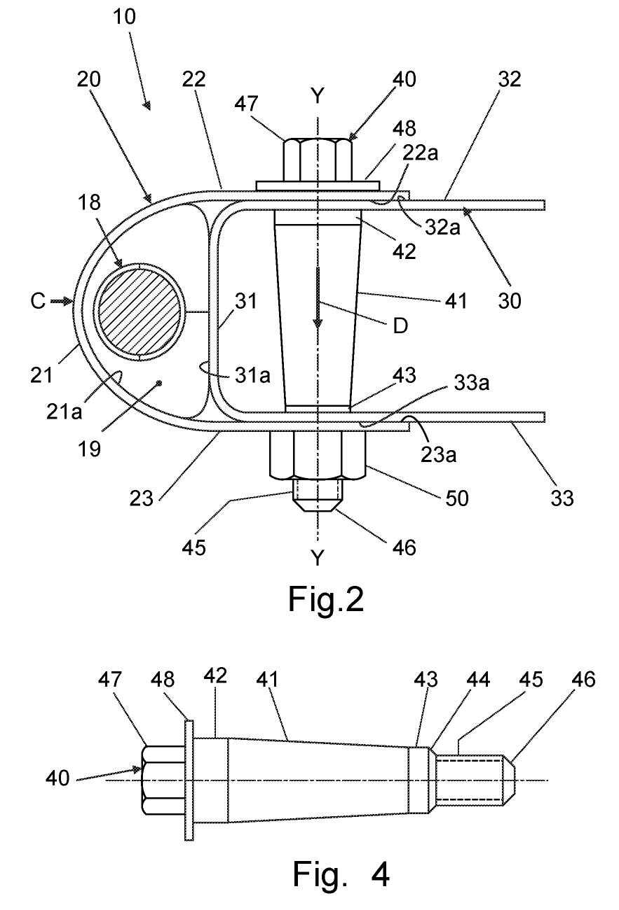

FIGS. 2 and 4 show an exemplary embodiment of the bushing assembly according to an exemplary embodiment of the present invention. The bushing assembly, seen generally at 10, includes a housing portion illustrated as a U-shaped member 20, a support portion illustrated as a U-shaped bracket 30, a split resilient, compressible bushing 19, an elongate member, typically a stabilizer or anti-roll bar 18 of a motor vehicle (not shown), and a clamping or force application member 40. As shown, the clamping member 40 extends through and engages apertures 24, 25 and 34, 35 located respectively in the housing 20 and support 30.

As used herein “housing portion” refers to a case, enclosure, or structure that mounts, secures, attaches, or holds the resilient, compressible bushing 19. As used herein “support portion” refers to a structure that secures, holds, or serves as a foundation. In the exemplary embodiment, the support portion may include a structural member that cooperates with the housing portion to attach or connect the resilient member 19 and correspondingly the stabilizer bar 18 to the vehicle frame or subframe.

The U-shaped member 20 has a first leg portion 22 having an aperture 24, a second leg portion 23 having an aperture 25 and a curved bridge or base portion 21 joining the first and second leg portions 22, 23 together. In the exemplary embodiment, the U-shaped member 20 is made from a single piece of pressed steel strip.

The U-shaped bracket 30 has a first leg portion 32 having an aperture 34, a second leg portion 33 having an aperture 35 and a flat or straight bridge or base portion 31 joining the first and second leg portions 32, 33 together. In the exemplary embodiment, the U-shaped bracket 30 is made from a single piece of pressed steel strip.

The two leg portions 32, 33 of the U-shaped bracket 30 are, in use, fastened by any convenient method such as, for example and without limitation, welding or bolting to a structural part, including the frame or subframe, of the motor vehicle of which the stabilizer or anti-roll bar 18 forms a part.

FIG. 2 shows the U-shaped member 20 engaging the U-shaped bracket member 30 so that inner surfaces 22a, 23a of first and second legs 22, 23 of the U-shaped member 20 interface with outer surfaces 32a, 33a of the first and second legs 32, 33 of the bracket member 30. In the shown example, the bracket member 30 is sandwiched between the first and second legs 22, 23 of the U-shaped member 20.

In the exemplary embodiment, the clamping member is a tapered member shown as a bolt 40 having a tapered shank 41 bounded at each end by first and second cylindrical lands 42, 43. The bolt 40 includes a head 47, a load spreading flange 48 adjacent the head 47, and a threaded portion 45 at the opposite end of the bolt 40 from the head 47. The bolt 40 has a longitudinal axis Y-Y that, when the bolt 40 is in a secured state, is arranged in a direction substantially ninety degrees to the direction where a clamping force is applied to the resilient, compressible bushing 19, with the direction of the clamping force indicated by an arrow C on FIGS. 2 and 3.

The bolt 40 further includes a lead-in or chamfer 44 between the second cylindrical land 43 and the threaded portion 45. A free end of the threaded portion 45 also has a chamfer 46 thereon. The chamfers 44, 46 ease the insertion of the bolt 40 into the apertures 24, 25 and 34, 35 in both the U-shaped member 20 and U-shaped bracket 30.

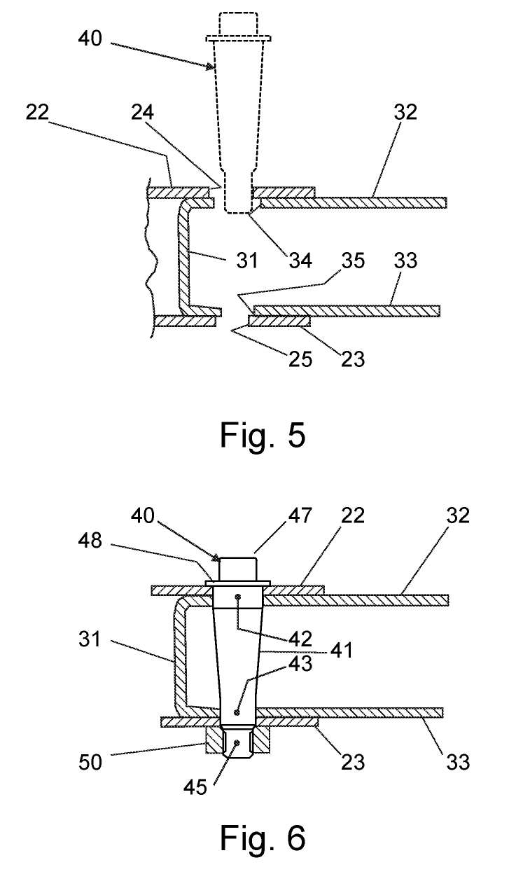

As best seen in FIGS. 3 and 5 the apertures 24, 25 in the U-shaped member 20 are displaced or misaligned with respect to the apertures 34, 35 in the U-shaped bracket 30 prior to insertion of the bolt 40. This misalignment is due to a mismatch between the uncompressed width of the resilient, compressible bushing 19 and the gap present between an inner face 21a of the bridge portion 21 of the U-shaped member 20 and an outer face 31a of the bridge portion 31 of the U-shaped bracket 30. The width of the uncompressed resilient, compressible bushing 19 is greater than the gap between the bridge portions 21, 31 when the apertures 24, 34, 25, 35 are aligned. The apertures 24, 34 in the first leg portions 22, 32 of the U-shaped clamp and U-shaped bracket 20, 30 form a first set of apertures and the apertures 25, 35 in the second leg portions 23, 33 of the U-shaped clamp and U-shaped bracket member 20, 30 form a second set of apertures.

When the bolt 40 is inserted into the apertures 24, 25, 34, 35 the tapered shank 41 interacts first with the apertures 24, 34 in the first leg portions 22, 32 of the U-shaped clamp and U-shaped bracket 20, 30 to displace or move the U-shaped clamp 20 in the direction of the arrow C. The lead-in chamfer 44 assists with the initial insertion of the bolt 40 in the apertures 24, 34 of the U-shaped clamp and U-shaped bracket 20, 30. Continued insertion of the bolt 40, in the direction indicated by an arrow ‘D’ on FIG. 2, causes the tapered shank 41 to begin aligning the aperture 24 of the U-shaped clamp 20 with the aperture 34 of the U-shaped bracket 30 and begin preloading or compressing the bushing 19. At the same time, the chamfer 46 guides the threaded portion 45 of the bolt 40 through the apertures 25, 35 in the second leg portions 23, 33 of the U-shaped clamp and U-shaped bracket member 20, 30 whereby the threaded portion 45 extends outwardly past or below the second leg portion 23 of the U-shaped clamp 20.

To continue the preload, the threaded portion 45 of the bolt 40 engages a threaded nut 50, whereby rotation of the bolt 40 tightens and pulls the bolt 40 in the respective apertures 24, 34, 25, 35 of the U-shaped clamp and U-shaped bracket member 20 and 30. Continued tightening of the threaded portion 45 of the bolt 40 on the nut 50 draws or pulls the tapered shank 41 through the apertures 24, 34 of the U-shaped clamp and U-shaped bracket 20, 30 and the lead-in chamfer 44 assists engagement of the second cylindrical land 43 with the apertures 25, 35 in the second leg portions 23, 33 of the U-shaped clamp and U-shaped bracket member 20 and 30. The nut 50 may be a weld nut attached to the U-shaped bracket 30 or attached separately to the bolt 40. When attached as a weld nut, the nut 50 cooperates with chamfer 46 of the bolt 40 to draws the U-shaped clamp 30 in the direction C and compress the bushing 14.

Because insertion of the bolt 40 causes displacement of the U-shaped clamp 20 relative to the U-shaped bracket 30 the curved bridge portion 21 of the U-shaped clamp 20 moves closer to the flat bridge portion 31 of the U-shaped bracket 30. As the curved bridge portion 21 of the U-shaped clamp 20 moves closer to the flat bridge portion 31 of the U-shaped bracket 30 it compresses the resilient, compressible bushing 19 and clamps the anti-roll or stabilizer bar 18 in the resilient, compressible bushing 19.

As shown, the diameter of the apertures 24, 34 in the first legs 22, 32 of the U-shaped clamp and U-shaped bracket 20, 30 are substantially the same. Similarly, the diameter of the apertures 25, 35 in the second legs 23, 33 of the U-shaped clamp and U-shaped bracket 20, 30 are also substantially the same. However, the diameter of the apertures 24, 34 in the first legs 22, 32 is larger than the diameter of the apertures 25, 35 in the second legs 23, 33.

As best seen in FIG. 6, when the bolt 40 is fully secured in position the first cylindrical portion 42 engages the apertures 24, 34 in the first legs 22, 32 and the second cylindrical land 43 engages the apertures 25, 35 in the second legs 23, 33.

The direction ‘D’ that the bolt 40 is inserted is arranged at substantially ninety degrees with respect to the direction ‘C’ where a clamping force is applied to the resilient, compressible bushing 19 by the displacement of the U-shaped clamp 20 relative to the U-shaped bracket 30.

Such an arrangement makes it unnecessary to have access to the clamping member 40 in a direction parallel to the direction of clamping indicated by the arrow ‘C’ on FIGS. 2 and 3. Therefore, a bushing and clamp assembly in accordance with this invention can be used in locations where access to a conventional bushing and clamp assembly of the type shown in FIG. 1 would prevent its use.

In the shown embodiment, the tapered shank 41 is a frustoconical shank; however, the shank could have other configurations including part cylindrical side portions and tapering front and rear faces that interact with the apertures 24, 34 23, 25 in the first and second legs 22, 32, 23, 33.

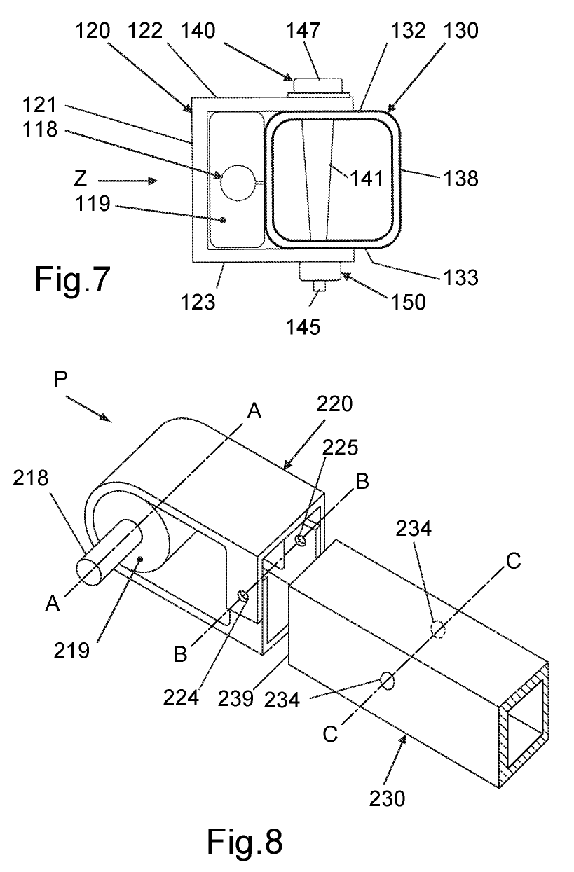

FIG. 7 shows an additional embodiment of a bushing and clamp assembly that in most respects is the same as previously described and differs primarily in that instead of being U-shaped bracket 30 the support portion is a structural component 130, which as shown, is in the form of a box section tube.

The bushing and clamp assembly includes a U-shaped clamp 120 having legs 122, 123 engaged with the structural member 130 and a clamping member 140 engaging the apertures (not shown) in the U-shaped clamp 120 and the structural member 130. A resilient, compressible bushing 119 supports a shaft or bar which is an anti-roll or stabilizer bar 118 of a motor vehicle (not shown). The resilient compressible bushing 119 is clamped between the U-shaped clamp 120 and the structural member 130.

The U-shaped clamp 120 is the same as the U-shaped clamp 20 previously described and will not be described again in detail with identical parts having the same reference numeral increased by 100.

The structural member 130 has an upper wall 132 forming a first leg portion 132 having an aperture, a lower wall 133 forming a second leg portion having an aperture, a front wall 131 forming a first bridge portion joining front ends of the first and second leg portions 132 and 133 together and a rear wall 138 forming a second bridge portion joining rear ends of the first and second leg portions 132, 133 together. The terms ‘upper’, ‘front’ and ‘rear’ are provided by way of example and that the orientation of the structural member 130 could be different to that shown.

The clamping member 140 is the same as the bolt 40 and identical parts have the same reference numeral increased by 100. The clamping member 140 will not be described again in detail.

As before, when the bolt 140 is inserted into the apertures in the U-shaped clamp 120 and the structural member 130, the tapered shank 141 interacts with the apertures in the first leg portions 122, 132 of the U-shaped clamp and structural members 120 and 130 to displace or move the U-shaped clamp 120 in the direction of the arrow ‘Z’ on FIG. 7.

As before, the direction of insertion of the bolt 140 is substantially at right angles to the direction ‘Z’ where the clamping force is applied to the resilient, compressible bushing 119 by the displacement of the U-shaped clamp 120. Providing the clamping force clamps the bar 118 in position and prevents relative rotation between the bar 118 and the resilient, compressible bushing 119.

FIGS. 2-7 show embodiments where the clamping member or bolt 40 is arranged at substantially ninety degrees with respect to both the direction of clamping and a longitudinal axis of the bar.

FIG. 8 shows diagrammatically an arrangement where the clamping member extends at substantially ninety degrees with respect to the direction of clamping but is arranged parallel to the longitudinal axis of the bar.

As shown, first and second clamp members 220 and 230 cooperate with one another to clamp a bushing 219 supporting an anti-roll or stabilizer bar 218. The anti-roll or stabilizer bar 218 extends along a longitudinal axis A-A arranged at substantially ninety degrees to the direction where the compressible bushing 219 is clamped by the U-shaped clamp 320. A tapered bolt (not shown) engages apertures 224, 225 lying on an axis B-B in the U-shaped clamp 220 and with corresponding apertures 234 lying on an axis C-C in the structural member 230.

The structural member 230 has an end plate 239 such that when the structural member 230 is inserted into the U-shaped clamp 220 the end plate 239 presses against the compressible bushing 219.

As before, the apertures 224, 225 in the U-shaped clamp 220 are misaligned with the apertures 234 in structural member 230 until insertion of the tapered bolt. Insertion of the tapered bolt draws or moves the U-shaped clamp 220 towards the structural member 230 thereby compressing the compressible bushing 219 by applying a clamping force in the direction of the arrow ‘P’ on FIG. 8.

When the U-shaped clamp and structural member 220, 230 are assembled with the tapered bolt in place the axes B-B and C-C are coaxially aligned with a longitudinal axis of the tapered bolt.

As set forth above, the clamping member may include a tapered elongate member extending in a longitudinal direction arranged at substantially ninety degrees with respect to both the direction in which the clamping member is inserted into the apertures and the direction in which a clamping force is applied to the compressible bushing by the relative displacement between housing portion and support portion. The tapered clamping member may have a frustoconical shank portion.

The tapered elongate member may be a bolt having a head, a threaded end portion and tapered shank located therebetween. In which case, the tapered shank may be a frustoconical shank bounded at each end by a cylindrical land.

Although the invention refers to embodiments where the clamping member is a tapered shank it will be appreciated that it is not limited to such a clamping member. For example and without limitation, the clamping member could be a tapering rod having thick and thin ends. The thin end having a threaded bore with which a threaded fastener such as a bolt is engaged to draw the tapering rod into position.

Although the invention has been described with reference to its use for supporting a motor vehicle anti-roll or stabilizer bar it could be used for other uses where a shaft, bar or tube needs to be attached to a support component or member by a bushing and clamp assembly.

It will be appreciated by those skilled in the art that although the invention has been described by way of example with reference to one or more embodiments it is not limited to the disclosed embodiments and that alternative embodiments could be constructed without departing from the scope of the invention as defined by the appended claims.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A bushing assembly comprising:
a U-shaped clamp having a pair of spaced apart legs joined by a bridge portion, each of said legs having an aperture;
a U-shaped bracket having a pair of spaced apart legs joined by a bridge portion, each of said legs having an aperture;
a compressible bushing interposed between the bridge portions of the U-shaped clamp and U-shaped bracket; and
a clamping member engaging the apertures in the first and second legs of the U-shaped clamp and U-shaped bracket and causing displacement of one of the U-shaped clamp and U-shaped bracket relative to the other thereby reducing a distance between the bridge portions of the U-shaped clamp and U-shaped bracket so as to compress the bushing wherein the direction in which the clamping member is orientated in the apertures is arranged at substantially ninety degrees with respect to a direction in which a clamping force is applied to the compressible bushing by the relative displacement between the U-shaped clamp and U-shaped bracket.

2. An assembly as claimed in claim 1 wherein an elongate member is arranged within the compressible bushing and the compression of the compressible bushing acts so as to clamp the elongate member in the compressible bushing.

3. An assembly as claimed in claim 2 wherein the elongate member extends in a longitudinal direction that is arranged at substantially ninety degrees with respect to both the direction in which the clamping member is oriented in the apertures and the direction in which the clamping force is applied to the compressible bushing by the relative displacement between U-shaped clamp and U-shaped bracket.

4. An assembly as claimed in claim 2 wherein the elongate member is a motor vehicle stabilizer bar.

5. An assembly as claimed in claim 1 wherein the clamping member includes a tapered bolt.

6. An assembly as claimed in claim 5 wherein the tapered bolt includes a frustoconical shank portion.

7. An assembly as claimed in claim 5 wherein the bolt includes a head, a threaded end portion and a tapered shank located therebetween.

8. An assembly as claimed in claim 5 wherein the tapered bolt includes a frustoconical shank bounded at each end by a cylindrical land.

9. An assembly as claimed in claim 5 wherein one cylindrical land is located adjacent the first set of apertures and the second cylindrical land is located in the second set of apertures.

10. A bushing assembly comprising:
a housing portion having an aperture;
a support portion having an aperture;
a compressible bushing interposed between the housing portion and support portion; and
a tapered clamping member engaging the aperture in the housing portion and the support portion causing displacement between the housing portion and support portion to compress the bushing wherein the clamping member is orientated in the apertures at substantially ninety degrees to a clamping force direction.

11. An assembly as claimed in claim 10 wherein the clamping member includes a tapered bolt.

12. An assembly as claimed in claim 11 wherein the tapered bolt includes a frustoconical shank portion.

13. An assembly as claimed in claim 11 wherein the bolt includes a head, a threaded end portion and a tapered shank located therebetween.

14. An assembly as claimed in claim 11 wherein the tapered bolt includes a frustoconical shank bounded at each end by a cylindrical land.

15. An assembly as claimed in claim 10 wherein the support portion includes a bracket, said bracket connected to a structural member.
